(19) United States
(12) Patent Application Publication
(10) Pub. No.: US 2025/0196452 A1
(43) Pub. Date: Jun. 19, 2025

(54) PULTRUSION MOLDING APPARATUS FOR MANUFACTURING A VEHICLE MEMBER HAVING A RIB

(71) Applicants: HYUNDAI MOTOR COMPANY, Seoul (KR); KIA CORPORATION, Seoul (KR)

(72) Inventor: Kyu-Young Lee, Ulsan (KR)

(73) Assignees: HYUNDAI MOTOR COMPANY, Seoul (KR); KIA CORPORATION, Seoul (KR)

(21) Appl. No.: 18/882,438

(22) Filed: Sep. 11, 2024

(30) Foreign Application Priority Data
Dec. 18, 2023 (KR) 10-2023-0184568

(51) Int. Cl. B29C 70/52; B29C 70/08; B29C 70/20; B29L 31/30

(52) U.S. Cl. CPC B29C 70/526; B29C 70/08; B29C 70/20; B29C 70/523; B29C 70/527; B29L 2031/3005

(57) ABSTRACT

A pultrusion molding apparatus for manufacturing a vehicle member. The interior of the vehicle member is divided into a plurality of regions by at least one rib and the vehicle member is formed from a composite material to have a constant thickness. The pultrusion molding apparatus includes a molding unit configured to mold the vehicle member by applying a fiber and a non-woven fabric while impregnating the fiber with a resin. The molding unit includes: an upper mold in which a space is formed; a lower mold disposed below the upper mold and coupled to the upper mold; and a mandrel configured to be inserted into a gap formed between the upper mold and the lower mold and having one end fastened to the upper mold.

### CROSS-REFERENCE(S) TO RELATED APPLICATIONS

This application claims priority to Korean Patent Application No. 10-2023-0184568, filed on Dec. 18, 2023, which is incorporated herein by reference in its entirety.

### BACKGROUND

### Field

The present disclosure relates to a pultrusion molding apparatus for manufacturing a vehicle member made of a composite material.

### Description of Related Art

A vehicle body is usually manufactured to have rigidity by processing a metal plate to form a bent cross-section or a closed cross-section.

As shown in FIG. 1, a metal plate is processed to manufacture a seat cross member 110, a center floor panel 121, a side sill outer 122, and a center pillar 123 to constitute a vehicle body.

Recently, in order to reduce the weight of a vehicle, the application of a composite material using a resin as a main material is increasing instead of a metal plate.

For example, the seat cross member 110 formed with a body 111 having a cross section as shown in FIG. 2 is formed using a resin as a main material and is formed through a pultrusion molding process. Since it is difficult to obtain sufficient rigidity with the resin alone, the seat cross member 110 is manufactured by impregnating a fiber with the resin.

Like the seat cross member 110, a variety of vehicle body members made of composite materials are manufactured through a vehicle body member molding device as shown in FIGS. 3 and 4. The vehicle body member molding device includes an upper mold 131, a lower mold 132, and a mandrel 133. In a state in which the mandrel 133 is inserted between the upper mold 131 and the lower mold 132, a reinforced fiber, such as a carbon fiber or a glass fiber, passes through a gap formed between the upper mold 131, the lower mold 132, and the mandrel 133, while injecting a molten resin, thereby impregnating the fiber with the resin.

The fiber and the resin are integrally molded while passing through the upper mold 131, the lower mold 132, and the mandrel 133. Since the upper mold 131, the lower mold 132, and the mandrel 133 are disposed in a longitudinal direction of the vehicle body member molding apparatus as shown in FIG. 4, the fiber and the resin are supplied through one end of the vehicle body member molding device. The molded vehicle body member is pulled from the other end, and thus a vehicle body member with a constant cross-section is manufactured.

A vehicle body member such as the seat cross member 110 has a plurality of ribs 112 formed therein to improve strength thereof as shown in FIG. 5. In other words, the plurality of ribs 112 are formed inside the body 111 constituting the seat cross member 110 to improve the rigidity of the seat cross member 110.

The seat cross member 110 is disposed in a widthwise direction of the vehicle, and thus in the event of a side collision of the vehicle, the seat cross member 110 is configured to support a side portion of the vehicle to reduce injuries to occupants in the interior of the vehicle.

In particular, as the number of electric vehicles is increasing, in order to expand a compartment space and secure a battery installation space, a battery is installed below the center floor panel 121.

However, there is a risk of the battery exploding in the event of a collision, and thus the seat cross member 110 serves to support a collision load to prevent the battery from being damaged by the collision.

When the seat cross member 110 has a cross-section in which the ribs 112 are not formed, the seat cross member 110 may be deformed in the event of a side collision, hitting a side portion of the battery, and thus causing a fire to occur from the battery.

In order to form the ribs 112 in the seat cross member 110, the mandrel 133 should be divided into separate pieces (see FIG. 6). However, one end of the mandrel 133 is fixed to an outer side of the upper mold 131 and the lower mold 132 in the form of a cantilever.

In addition, in order to prevent a fiber impregnated with resin from coming out, a non-woven fabric should be attached to a surface of the seat cross member 110. As shown in FIG. 7, an outer upper non-woven fabric 114a, an outer lower non-woven fabric 114b, an inner upper non-woven fabric 114c, and an inner lower non-woven fabric 114d should be attached to the surface of the seat cross member 110.

Thus, one end of the mandrel 133 is fixed at a position spaced apart from the upper mold 131 and the lower mold 132, and a fiber to be impregnated with the resin and the non-woven fabrics to be attached to the surface of the seat cross member 110 are put into a space between the mandrel 133, the upper mold 131, and the lower mold 132.

Therefore, since the one end of the mandrel 133 is fixed at the position spaced apart from the upper mold 131 and the lower mold 132, the mandrel 133 is inevitably sagged due to the self-weight of the mandrel 133.

As described above, since sagging occurs at the other end of the mandrel 133, the thickness of the seat cross member 110 becomes uneven throughout its entire length.

### SUMMARY

An embodiment of the present disclosure is directed to providing a pultrusion molding apparatus for manufacturing a vehicle member having at least one rib, which uniformly may form a uniform cross-sectional thickness of a vehicle member constituting a vehicle body.

Other objects and advantages of the present disclosure may be understood by the following description and should become apparent with reference to the embodiments of the present disclosure. Also, it should be obvious to those having ordinary skill in the art to which the present disclosure pertains that the objects and advantages of the present disclosure can be realized by the means as claimed and combinations thereof.

In accordance with an embodiment of the present disclosure, there is provided a pultrusion molding apparatus for manufacturing a vehicle member. The pultrusion molding apparatus includes a molding unit configured to mold a vehicle member by impregnating a fiber passing therein with a resin. The molding unit may include: an upper mold in which a first space is formed; a lower mold disposed below the upper mold and having a second space corresponding to the first space of the upper mold; and a mandrel configured to be inserted into first and second spaces between the upper mold and the lower mold and having one end fastened to the upper mold.

A body of the vehicle member may be molded with a fiber and a resin applied through gaps between the upper mold and the mandrel and between the lower mold and the mandrel, respectively. The mandrel is divided into sub-mandrels along a longitudinal direction of the mandrel. The at least one rib of the vehicle member may be formed with the fiber and the resin that are provided through the first and second spaces between the upper and the lower molds and spaces between the divided mandrels (e.g., the sub-mandrels).

A mandrel mounting hole in which a first end of the mandrel is mounted may be formed at one end of the upper mold, and an assembly block mounted in the mandrel mounting hole may be fastened to a second end of the mandrel.

A front surface of the assembly block may be formed to be inclined downward. An upper fiber inlet through which the fiber is provided into between the upper mold and the mandrel may be formed on a surface of the upper mold facing the front surface of the assembly block.

The front surface of the assembly block and the upper fiber inlet of the upper mold may be formed parallel to each other. A first gap may be formed between the front surface of the assembly block and the upper fiber inlet.

A lower fiber inlet may be formed at one end of the lower mold. The lower fiber inlet may be parallel to a bottom surface of the assembly block of the assembly block, a second gap may be formed between the lower fiber inlet and the bottom surface, and the fiber may be provided into between the lower mold and the mandrel through the second gap.

An upper resin inlet through which the resin is injected into an interior of the upper mold may be formed to pass through the upper mold at a predetermined distance from the assembly block. A lower resin inlet through which the resin is injected into an interior of the lower mold may be formed to pass through the lower mold below the upper resin inlet.

A cross-sectional area of a portion where the upper resin inlet and the lower resin inlet intersect in the mandrel may be formed to be smaller than those of other portions of the mandrel. The upper mold and the lower mold may each be formed to have a thin thickness.

The fiber provided into the upper mold and the lower mold may include a reinforced fiber disposed inside the vehicle member, and a non-woven fabric which is disposed on a surface of the vehicle member and configured to prevent the reinforced fiber from being separated.

An upper reinforced fiber molded into an upper portion of the vehicle member, and an outer upper non-woven fabric and an inner upper non-woven fabric surrounding upper and lower portions of the upper reinforced fiber may be provided into between the upper mold and the mandrel. A lower reinforced fiber molded into a lower portion of the vehicle member and the rib of the vehicle member, a lower side non-woven fabric surrounding both side surfaces of the lower reinforced fiber, an inner lower non-woven fabric surrounding an interior of the lower reinforced fiber, and an outer lower non-woven fabric surrounding a lower portion of the lower reinforced fiber may be provided into between the lower mold and the mandrel.

An upper reinforced fiber molded into an upper portion of the vehicle member, and an outer upper non-woven fabric and an inner upper non-woven fabric surrounding upper and lower portions of the upper reinforced fiber may be provided into between the upper mold and the mandrel. A lower reinforced fiber molded into a lower portion of the vehicle member and the rib of the vehicle member, an inner lower non-woven fabric surrounding both side surfaces and an interior of the lower reinforced fiber, and an outer lower non-woven fabric surrounding a lower portion of the lower reinforced fiber may be provided into between the lower mold and the mandrel.

The pultrusion molding apparatus may further include a plurality of pullers configured to convey the vehicle member discharged from the molding unit in a longitudinal direction of the vehicle member.

Each of the plurality of pullers may include a housing and a roller rotatably installed inside the housing and configured to convey the vehicle member by coming into contact with the upper and lower surfaces of the vehicle member passing through an interior of the housing.

Each puller may further include a conveying plate configured to support the upper and lower surfaces of the vehicle member inside the housing.

The plurality of pullers may be disposed at intervals in a direction in which the vehicle member is discharged.

One end of the molding unit may be connected to a fixing unit configured to guide and fix a position of the fiber to be put into the upper mold and the lower mold.

Another embodiment of a pultrusion molding apparatus for manufacturing a vehicle member is provided. The pultrusion molding apparatus may include: a molding unit configured to mold a vehicle member having a rib by applying a reinforced fiber and a non-woven fabric while impregnating the reinforced fiber passing therein with a resin; a plurality of pullers configured to convey the vehicle member discharged from the molding unit in a longitudinal direction of the vehicle member; a guide unit configured to guide the reinforced fiber and the non-woven fabric to be supplied to the molding unit; and a fixing unit configured to fix the guide unit against the molding unit.

The guide unit may include a plurality of guide plates disposed at intervals in the longitudinal direction of the vehicle member, and through-holes through which the reinforced fiber and the non-woven fabric pass.

The molding unit may include: an upper mold in which a first space is formed; a lower mold disposed below the upper mold and having a second space corresponding to that of the upper mold; and a mandrel inserted into the first and second spaces between the upper mold and the lower mold and having one end fastened to the upper mold.

The molding unit may further include: a mandrel mounting hole in which a first end of the mandrel is mounted is formed at one end of the upper mold; and an assembly block mounted in the mandrel mounting hole is fastened to a second end of the mandrel.

### BRIEF DESCRIPTION OF THE DRAWINGS

The above and other objects, features, and advantages of the present disclosure should be more apparent from the following detailed description taken in conjunction with the accompanying drawings below.

FIG. 1 is a perspective view illustrating a lower structure of a conventional vehicle.

FIG. 2 is a cross-sectional view illustrating a seat cross member according to the related art.

FIG. 3 is a cross-sectional view illustrating a mold for forming the seat cross member according to the related art.

FIG. 4 is a side cross-sectional view illustrating the mold for forming the seat cross member according to the related art.

FIG. 5 is a cross-sectional view illustrating the seat cross member in which ribs are formed according to the related art.

FIG. 6 is a perspective view illustrating a mandrel for manufacturing the seat cross member in which the ribs are formed according to the related art.

FIG. 7 is a cross-sectional view illustrating an example in which a non-woven fabric is disposed on an outer surface of the seat cross member according to the related art.

FIG. 8 is a perspective view illustrating a pultrusion molding apparatus for manufacturing a vehicle member having a rib according to the present disclosure.

FIG. 9 is a perspective view illustrating a molding unit in the pultrusion molding apparatus for manufacturing a vehicle member having a rib according to the present disclosure.

FIG. 10 is a cross-sectional view taken along line A-A of FIG. 8.

FIG. 11 is a cross-sectional view taken along line C-C of FIG. 10.

FIG. 12 is a cross-sectional view taken along line B-B of FIG. 8.

FIG. 13 is a cross-sectional view illustrating an example in which a non-woven fabric is disposed in the pultrusion molding apparatus for manufacturing a vehicle member having a rib according to the present disclosure.

FIG. 14 is a cross-sectional view illustrating another example in which a non-woven fabric is disposed in the pultrusion molding apparatus for manufacturing a vehicle member having a rib according to the present disclosure.

FIG. 15 is a perspective view illustrating yet another example of a guide unit for arranging a non-woven fabric in the pultrusion molding apparatus for manufacturing a vehicle member having a rib according to the present disclosure.

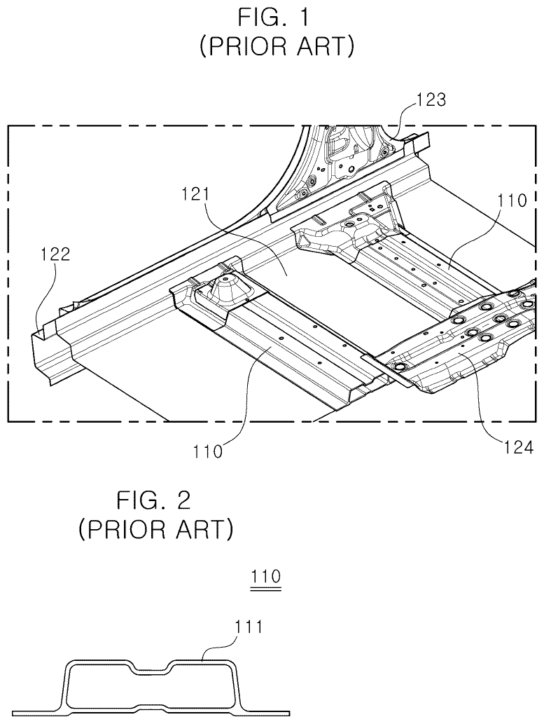

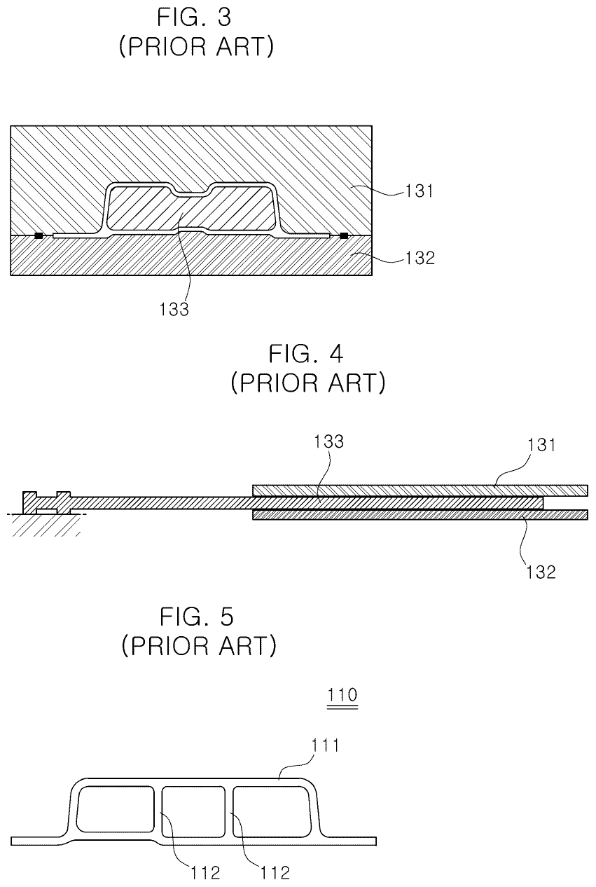

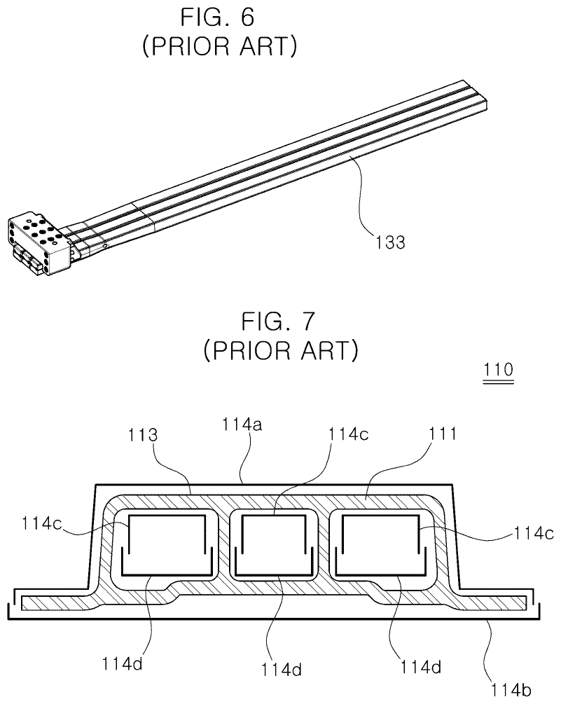

### DETAILED DESCRIPTION

Embodiments are hereinafter described in detail with reference to the accompanying drawings.

The embodiments disclosed in the present specification and the constructions depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted. Also, the same elements or equivalents are referred to with the same reference numerals throughout the specification.

Also the size and thickness of each element are arbitrarily shown in the drawings, but the present disclosure is not necessarily limited thereto. Additionally, in the drawings, the thickness of layers, films, panels, regions, and the like, may be exaggerated for clarity.

When a component, device, element, or the like of the present disclosure is described as having a purpose or performing an operation, function, or the like, the component, device, or element should be considered herein as being “configured to” meet that purpose or perform that operation or function.

Hereinafter, a pultrusion molding apparatus for manufacturing a vehicle member having a rib according to the present disclosure is described in detail with reference to the accompanying drawings.

The pultrusion molding apparatus 1 for manufacturing a vehicle member 10 according to the present disclosure may include a molding unit 30 for molding the vehicle member 10 by impregnating a fiber passing therein with a resin. The molding unit 30 includes an upper mold 31 in which a space is formed, and a lower mold 32 disposed below the upper mold 31 and having a circumference fastened to the upper mold 31. The molding unit 30 also includes a mandrel 33 inserted into the upper mold 31 and the lower mold 32 and having one end fastened to the upper mold 31.

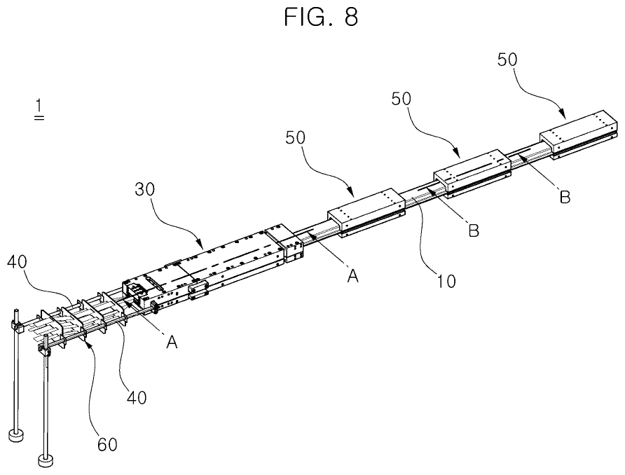

The molding unit 30 may manufacture the vehicle member 10, such as a seat cross member, by impregnating a fiber passing therein with a resin. FIGS. 8-14 show the seat cross member as an example of the vehicle member 10. The fiber passing through the molding unit 30 includes a reinforced fiber disposed inside the vehicle member 10 to reinforce rigidity, and a non-woven fabric for surrounding the reinforced fiber to be disposed on a surface of the vehicle member 10 to prevent the reinforced fiber from being separated. The reinforced fiber includes a carbon fiber, a glass fiber, or the like, and thus there is an effect in that the vehicle member 10 molded in the molding unit 30 is made of a composite material such as carbon fiber reinforced plastic (CFRP) or glass fiber reinforced plastic (GFRP). The non-woven fabric may be a glass fiber. In the present disclosure, at least one rib 12 may be applied to an interior of the body 11 in the vehicle member 10 to reinforce rigidity while dividing an internal space of the body 11 so that an expensive carbon fiber is not applied as the reinforced fiber and only a glass fiber may be applied. Thus, the rigidity required for the vehicle member 10 can be achieved and costs can be reduced.

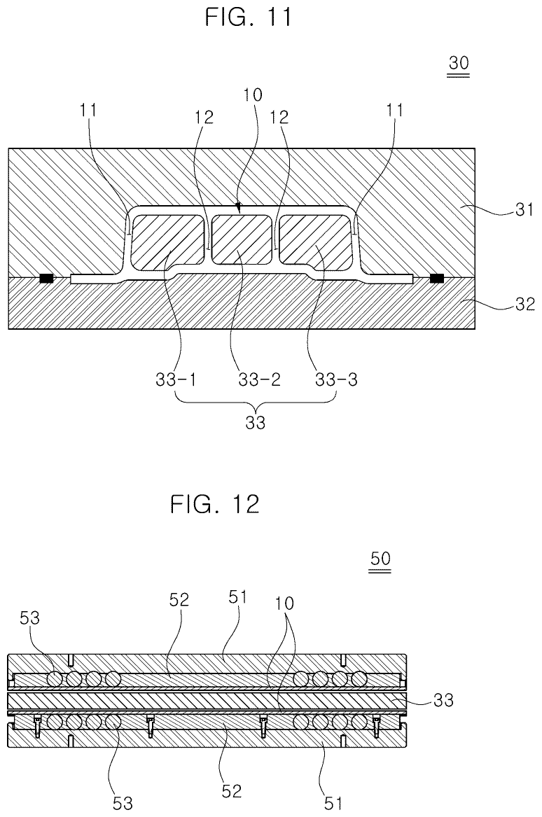

The molding unit 30 includes the upper mold 31 in which a space is formed, the lower mold 32 disposed below the upper mold 31 and having a circumference fastened to the upper mold 31, and a mandrel 33 which is divided into plurality of sub-mandrels, e.g., three sub-mandrels 33-1, 33-2 and 33-3 into sub-mandrels along a longitudinal direction of the mandrel 33 as shown in FIG. 11. Each of the plurality of sub-mandrels 33-1, 33-2 and 33-3 is inserted into the space between the upper mold 31 and the lower mold 32. Each one end the plurality of sub-mandrels 33-1, 33-2 and 33-3 is fastened to the upper mold 31. For purpose of simple descriptions of the molding unit 30, the plurality of sub-mandrels 33-1, 33-2 and 33-3 is referred to as a mandrel 33 hereinbelow.

The upper mold 31 and the lower mold 32 are correspondingly coupled to each other. A space S1 and S2 corresponding to the vehicle member 10 may be formed therein.

The mandrel 33 may be disposed at such space S1 and S2 between the upper mold 31 and the lower mold 32 to form the vehicle member 10.

The upper mold 31 has a groove (not shown) formed at a lower portion of an inside thereof in a longitudinal direction to form a protruding portion of the vehicle member 10.

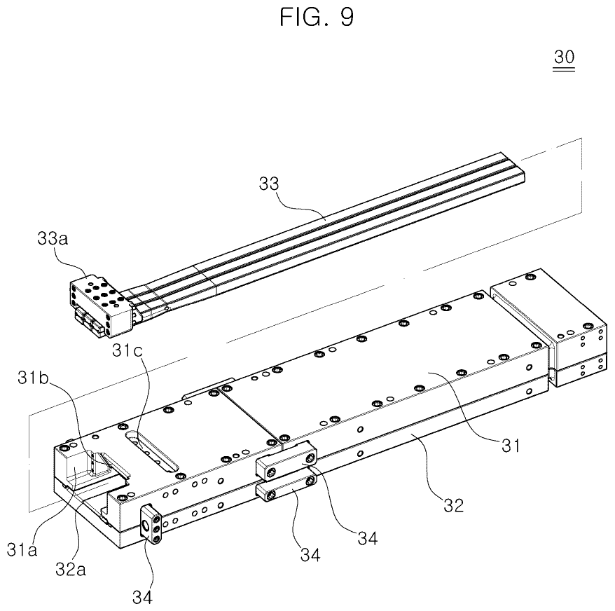

Referring to FIG. 9, a mandrel mounting hole 31a to which the mandrel 33 is fastened may be formed at one end of the upper mold 31. In other words, the mandrel mounting hole 31a may be formed at an end side where the reinforced fiber and the resin are supplied. The mandrel mounting hole 31a may be formed in a concave shape from the one end of the upper mold 31 toward the other end by removing a portion from the one end of the upper mold 31.

In the upper mold 31, an upper fiber inlet 31b may be formed at one side of the mandrel mounting hole 31a. In the mandrel mounting hole 31a, a front surface of the vehicle member 10 in a molding processing direction (from a lower left portion to an upper right portion in FIGS. 8 and 9) may be formed as an inclined surface, and the front surface becomes the upper fiber inlet 31b.

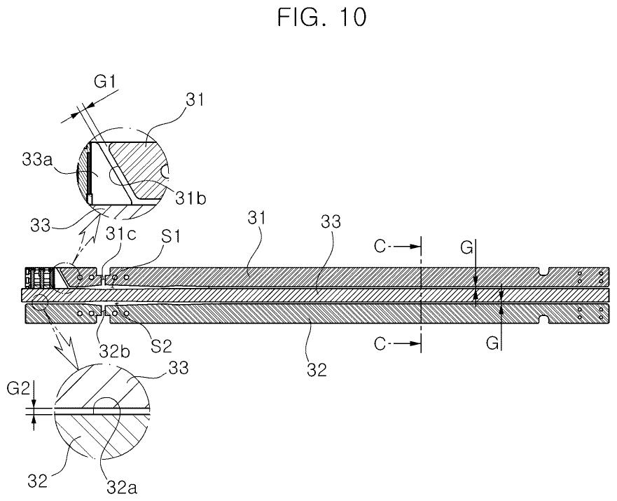

An upper resin inlet 31c for injecting a resin into the space between the upper mold 31 and the lower mold 32 may be formed in the upper mold 31. The upper resin inlet 31c may be formed with an interval from the upper fiber inlet 31b. The upper resin inlet 31c may be positioned ahead of the upper fiber inlet 31b in a molding processing direction as shown in FIG. 10. In other words, the reinforced fiber and the non-woven fabric, which are supplied through the upper resin inlet 31c, may pass through the upper resin inlet 31c and then pass through the upper fiber inlet 31b.

The lower mold 32 may be fastened to a lower portion of the upper mold 31. The reinforced fiber may be impregnated with the resin while the reinforced fiber and resin flow into the space formed between the lower mold 32 and the upper mold 31 so that the vehicle member 10 made of a composite material is manufactured.

One end of the lower mold 32 may become a lower fiber inlet 32a into which the reinforced fiber and the non-woven fabric are put.

A lower resin inlet 32b for injecting a resin into the space between the upper mold 31 and the lower mold 32 may also be formed in the lower mold 32. When the upper mold 31 and the lower mold 32 are assembled, the lower resin inlet 32b may be formed to be positioned directly below the upper resin inlet 31c.

One end of the mandrel 33 may be fastened to one end of the upper mold 31, and the remaining may be inserted between the upper mold 31 and the lower mold 32. The remaining portion of the mandrel 33, excluding the one end fastened to the upper mold 31, may form a gap G along with the upper mold 31 and the lower mold 32, and the vehicle member 10 may be manufactured by the resin flowing through the gap G.

The body 11 of the vehicle member 10 may be formed by the resin flowing in the gap G between the mandrel 33 and the upper mold 31 and by the resin flowing in the gap G between the mandrel 33 and the lower mold 32.

The mandrel 33 may be formed in a divided form to form the at least one rib 12 inside the vehicle member 10.

Since a length of the mandrel 33 is formed to be shorter than the lengths of the upper mold 31 and the lower mold 32, the other end of the mandrel 33 may be positioned inside the upper mold 31 and the lower mold 32.

An assembly block 33a may be provided to fasten one end of the mandrel 33 to the upper mold 31. The assembly block 33a may be first fastened to the mandrel 33, and then the assembly block 33a may be fastened to the mandrel mounting hole 31a, and thus the mandrel 33 may be fastened to the upper mold 31.

Since one end of the mandrel 33 is fastened to one end of the upper mold 31 and the lower mold 32, stability may be improved compared to the related art in which one end of the mandrel is positioned outside the upper mold and the lower mold.

The reinforced fiber and the non-woven fabric, which are required to form the vehicle member 10, are put into the assembly block 33a through a gap G1 formed between a front surface of the assembly block 33a and the upper fiber inlet 31b. The front surface of the assembly block 33a may be formed to be inclined downward in the molding processing direction, the upper fiber inlet 31b may be formed parallel to the front surface of the assembly block 33a, and the gap G1 may be formed between the upper fiber inlet 31b and the front surface. Thus, the reinforced fiber and the non-woven fabric are put through the gap G1. Since the front surface of the assembly block 33a is formed to be inclined downward, fibers, i.e., the reinforced fiber and the non-woven fabric, may be easily moved between the upper mold 31 and the mandrel 33.

The reinforced fiber, which is injected through the gap Gl between the front surface of the assembly block 33a and the upper fiber inlet 31b, may be applied to strengthen the upper portion of the vehicle member 10. The non-woven fabric put through the gap G1 may surround a surface of the upper portion of the vehicle member 10 and may prevent the reinforced fiber from being separated.

Another gap G2 may be formed between a bottom surface of the assembly block 33a and the lower fiber inlet 32a, and the reinforced fiber and the non-woven fabric are put into through the gap G2. The bottom surface of the assembly block 33a and the lower fiber inlet 32a may be formed parallel to each other, and the reinforced fiber, which is put into through the gap G2 formed between the bottom surface of the assembly block 33a and the lower fiber inlet 32a, may be applied to strengthen the strength of the lower portion of the vehicle member 10. In addition, the non-woven fabric put into through the gap G2 may surround a surface of the lower portion of the vehicle member 10 and may prevent the reinforced fiber from being separated from the lower portion of the vehicle member 10.

In a portion where the upper resin inlet 31c and the lower resin inlet 32b are positioned in the mandrel 33, a cross-sectional area of the mandrel 33 may be formed to be smaller than those of other portions. Referring to FIG. 10, the portion where the upper resin inlet 31c and the lower resin inlet 32b are positioned in the mandrel 33 may have a height that is lower than those of other portions, and the upper mold 31 and the lower mold 32 are each shown to have a thinner thickness.

Thus, a space S1 between the upper mold 31 and the mandrel 33 in the portion where the upper resin inlet 31c is formed may be greater than those in other portions. Additionally, a space S2 between the lower mold 32 and the mandrel 33 may be formed to be greater than those of other portions even in the portion where the lower resin inlet 32b is formed so that impregnation of the reinforced fiber with the resin in the spaces S1 and S2 is facilitated. In other words, since more resin is present in the spaces S1 and S2 compared to other portions, impregnation of the reinforced fiber with the resin may be facilitated.

When the upper mold 31 and the lower mold 32 are assembled together, or when the upper mold 31 or the lower mold 32 is manufactured in a divided state, a fastening block 34 may be used to fasten the upper mold 31 and the lower mold 32 together. Referring to FIG. 9, an example is shown in which the upper mold 31 and the lower mold 32, which are separable from each other, may be integrally fastened with each other using the fastening block 34, and the upper mold 31 and the lower mold 32 may be integrally fastened with each other.

As shown in FIG. 9, in order to fasten the lower mold 32 to the upper mold 31 which are separated, the fastening block 34 may be disposed outside the lower mold 32 and the upper mold 31 and may be fastened to the upper mold 31 and the lower mold 32 with a fastening bolt so that the upper mold 31 and the lower mold 32 are integrated with each other.

A puller 50 may convey the vehicle member 10 which has been molded and taken out from the molding unit 30. The puller 50 may convey the vehicle member 10 in the longitudinal direction of the vehicle member 10.

Referring to FIG. 12, the puller 50 may include a housing 51, a conveying plate 52 for supporting the upper and lower surfaces of the vehicle member 10 inside the housing 51, and a roller 53 rotatably installed inside the housing 51 and configured to convey the vehicle member 10 by coming into contact with the upper and lower surfaces of the vehicle member 10.

A space may be formed inside the housing 51, and the vehicle member 10 discharged from the molding unit 30 may pass through the space.

The conveying plate 52 may be installed inside the housing 51 and may support the upper and lower surfaces of the vehicle member 10 passing through the puller 50. The conveying plate 52 may support the upper and lower surfaces of the vehicle member 10 inside the housing 51.

The roller 53 may be installed inside the housing 51. The roller 53 may transfer a driving force to the vehicle member 10, to move the vehicle member 10 in a direction in which the puller 50 is disposed. In one embodiment, a plurality of roller 53 may be installed at a plurality of points and rotated by a driving motor (not shown). The rollers 53 may also come into contact with the upper and lower surfaces of the vehicle member 10. When the rollers 53 are driven by the driving motor, the rollers 53 may convey the vehicle member 10.

In another embodiment, a plurality of pullers 50 may be installed in the longitudinal direction of the vehicle member 10. FIG. 8 shows an example in which three pullers 50 are disposed.

A conveying speed of the vehicle member 10 inside the puller 50 may be synchronized with a speed at which the vehicle member 10 is taken out from the molding unit 30. For example, when the vehicle member 10 is taken out from the molding unit 30 at a speed of 0.3 meters per minute (m/min), each puller 50 may also move the vehicle member 10 at the same speed of 0.3 m/min.

In FIG. 8, one end of the molding unit 30 may be connected to a fixing unit 40 for fixing a guide unit 60 configured to guide positions of the reinforced fiber and the non-woven fabric to be supplied. A reel (not shown) on which the reinforced fiber and the non-woven fabric are wound may be installed in the fixing unit 40, and the reinforced fiber and the non-woven fabric may be unwound from the reel and supplied to the molding unit 30.

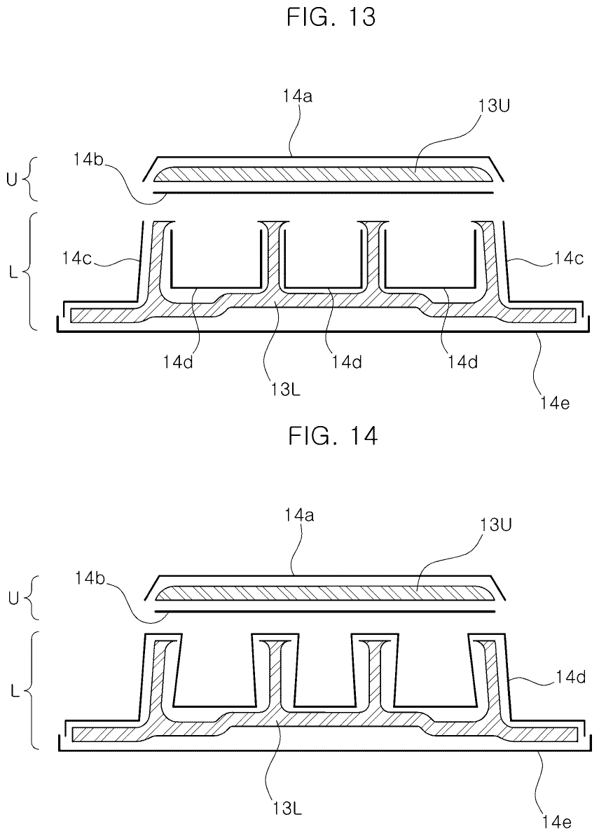

FIG. 13 shows one example of an arrangement of the reinforced fiber and the non-woven fabric put into the upper fiber inlet 31b and the lower fiber inlet 32a.

As mentioned above, at least one rib may be formed. In one embodiment, a plurality of ribs 12 may be formed inside the vehicle member 10, the reinforced fiber and the non-woven fabric may be each divided into upper and lower portions and may be put into between the upper mold 31 and the lower mold 32.

For example, in order to form an upper end in the vehicle member 10, an upper reinforced fiber 13U may be disposed. Upper and lower portions of the upper reinforced fiber 13U may be surrounded by an outer upper non-woven fabric 14a and an inner upper non-woven fabric 14b.

In addition, in order to form a lower end and the ribs 12 in the vehicle member 10, a lower reinforced fiber 13L may be disposed. A lower portion of the lower reinforced fiber 13L may be surrounded by an outer lower non-woven fabric 14e. Both side surfaces of the lower reinforced fiber 13L may be surrounded by the lower side non-woven fabric 14c, and a portion to be formed as the rib 12 in the lower reinforced fiber 13L may be surrounded by an inner lower non-woven fabric 14d.

In FIG. 13, a portion shown as section U may be put into the upper mold 31 through the upper fiber inlet 31b, and a portion shown as section L may be put into the lower mold 32 through the lower fiber inlet 32a.

FIG. 15 shows an example of the guide unit 60 in which the non-woven fabrics 14a, 14b, 14c, 14d, and 14e are disposed on the upper reinforced fiber 13U and the lower reinforced fiber 13L.

In the guide unit 60, a plurality of guide plates 61, 62, 63, and 64 may be disposed at intervals, and through-holes through which the upper reinforced fiber 13U, the lower reinforced fiber 13L, and the non-woven fabrics 14a, 14b, 14c, 14d, and 14e pass may be formed in the guide plates 61, 62, 63, and 64.

Each of the non-woven fabrics 14a, 14b, 14c, 14d, and 14e may pass through the plurality of guide plates 61, 62, 63, and 64 and may be guided in a form surrounding the upper reinforced fiber 13U and the lower reinforced fiber 13L in a cross-sectional shape. In addition, each of the non-woven fabrics 14a, 14b, 14c, 14d, and 14e may pass through each of the guide plates 61, 62, 63, and 64 and may be sequentially guided to approach a final cross-sectional shape.

The upper reinforced fiber 13U and the lower reinforced fiber 13L may be disposed between the non-woven fabrics 14a, 14b, 14c, 14d, and 14e and conveyed. Additionally, the non-woven fabrics 14a, 14b, 14c, 14d, and 14e may be disposed adjacent to the upper reinforced fiber 13U and the lower reinforced fiber 13L while passing through the guide plates 61, 62, 63, and 64.

Referring to FIG. 15, a configuration is shown in which a first guide plate 61 to a fourth guide plate 64 are disposed at intervals from each other inside the guide unit 60.

Though-holes through which the upper reinforced fiber 13U, the lower reinforced fiber 13L, and the non-woven fabrics 14a, 14b, 14c, 14d, and 14e pass may be formed in each of the guide plates 61, 62, 63, and 64. In FIG. 15, a through-hole 61a through which the upper reinforced fiber 13U passes may be formed in the first guide plate 61, and through-holes 62a and 62b through which the upper reinforced fiber 13U and the lower reinforced fiber 13L pass may only be shown in the second guide plate 62. However, through-holes through which the upper reinforced fiber 13U, the lower reinforced fiber 13L, and the non-woven fabrics 14a, 14b, 14c, 14d, and 14e pass may be formed in each of the guide plates 61, 62, 63, and 64.

The upper reinforced fiber 13U may enter an interior of the guide unit 60 through the through-hole formed in the first guide plate 61 and may pass through the second guide plate 62, the third guide plate 63, and the fourth guide plate 64 in the form of passing the through-holes formed in the second guide plate 62, the third guide plate 63, and the fourth guide plate 64. The lower reinforced fiber 13L may also pass through the first guide plate 61 and then may sequentially pass through the second guide plate 62, the third guide plate 63, and the fourth guide plate 64. Similarly, the non-woven fabrics 14a, 14b, 14c, 14d, and 14e may also pass through the first guide plate 61 and then pass through the second guide plate 62 to the fourth guide plate 64. The non-woven fabrics 14a, 14b, 14c, 14d, and 14e may surround the upper reinforced fiber 13U and the lower reinforced fiber 13L, and thus predetermined cross sections may be gradually formed along a direction from the first guide plate 61 toward the fourth guide plate 64. Thus, the cross sections of the non-woven fabrics 14a, 14b, 14c, 14d, and 14e may pass through the first guide plate 61 in a flat state, but the cross sections may be gradually deformed while passing through the second guide plate 62 and the third guide plate 63. Additionally, the cross sections may be processed into final shapes having the cross sections while passing through the fourth guide plate 64.

The reinforced fibers and the non-woven fabrics may be impregnated with the resin injected through the upper resin inlet 31c and the lower resin inlet 32b while the reinforced fibers and the non-woven fabrics are moved between the upper mold 31 and the mandrel 33 and between the lower mold 32 and the mandrel 33. Since the liquid resin can infiltrate the reinforced fibers and the non-woven fabrics, even when the reinforced fibers are surrounded by the non-woven fabrics, the reinforced fibers may be impregnated with the resin.

While passing through the upper mold 31 and the lower mold, curing operation may be performed where the resin impregnates between the reinforced fibers by applying heat and pressure to complete manufacturing of the vehicle member 10.

The pullers 50 installed next to the molding unit 30 may pull and convey the vehicle member 10 passing through the molding unit 30.

The resin may be supplied to the upper mold 31 and the lower mold 32 while the reinforced fibers and the non-woven fabrics are supplied through one end of the molding unit 30. Heat and pressure are applied to the upper mold 31 and the lower mold 32. Thus, the vehicle member 10, such as the seat cross member, may be finally obtained.

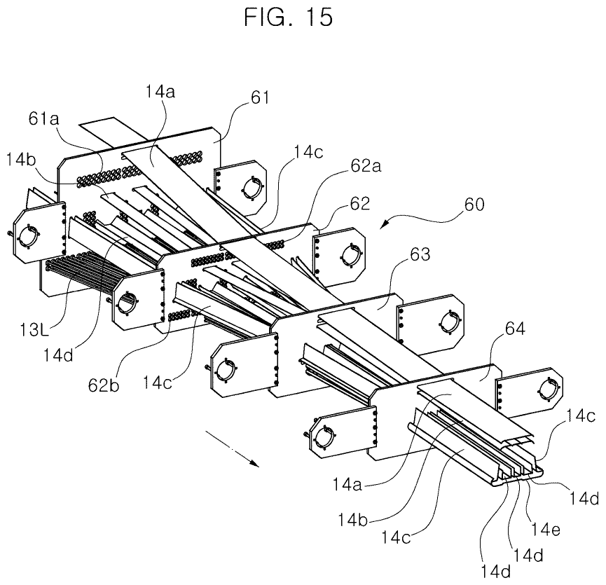

FIG. 14 shows another example of an arrangement of the reinforced fibers and the non-woven fabrics put into the upper fiber inlet 31b and the lower fiber inlet 32a.

In the present example, as the above-described example, in the upper portion of the vehicle member 10, in order to form an upper end in the vehicle member 10, an upper reinforced fiber 13U may be disposed, and upper and lower portions of the upper reinforced fiber 13U may be surrounded by an outer upper non-woven fabric 14a and an inner upper non-woven fabric 14b.

In addition, in order to form a lower end and the ribs 12 in the vehicle member 10, a lower reinforced fiber 13L may be disposed, and a lower portion of the lower reinforced fiber 13L may be surrounded by an outer lower non-woven fabric 14e. However, the upper portion of the lower reinforced fiber 13L may be integrally surrounded with the inner lower non-woven fabric 14d, including a side surface of the lower reinforced fiber 13L and an upper end of the rib 12.

In accordance with a pultrusion molding apparatus 1 for manufacturing a vehicle member 10 having at least one rib 12 of the present disclosure with the above-described configuration, one end of a mandrel 33 may be fixed to an upper mold 31 and a lower mold 32 so that sagging of the mandrel 33 in the upper mold and lower mold 31 and 32 may be prevented.

Since the sagging of the mandrel 33 is prevented, a gap G between the mandrel 33, the upper mold 31, and lower mold 32 becomes uniform so that a thickness of the manufactured vehicle member 10 may be uniform throughout its entire length.

While the present disclosure has been described with reference to the accompanying drawings, it should be apparent to those having ordinary skill in the art that various changes and modifications can be made without departing from the spirit and scope of the present disclosure and without being limited to the embodiments disclosed herein. Accordingly, it should be noted that such alterations or modifications fall within the claims of the present disclosure, and the scope of the present disclosure should be construed on the basis of the appended claims.

What is claimed is:

1. A pultrusion molding apparatus for manufacturing a vehicle member, the pultrusion molding apparatus comprising:
a molding unit configured to mold the vehicle member having at least one rib by impregnating a fiber passing therein with a resin,
wherein the molding unit includes:
an upper mold forming a first space;
a lower mold disposed below the upper mold and forming a second space corresponding to the first space; and
a mandrel having one end fastened to the upper mold and configured to be inserted into the first and second spaces between the upper mold and the lower mold.

2. The pultrusion molding apparatus of claim 1, wherein:
a body of the vehicle member is molded with a fiber and a resin provided through gaps between the upper mold and the mandrel and between the lower mold and the mandrel, respectively;
the mandrel is divided into sub-mandrels along a longitudinal direction of the mandrel; and
the at least one rib of the vehicle member is formed with the fiber and the resin provided through the first and second spaces between the upper and the lower molds and spaces between the sub-mandrels.

3. The pultrusion molding apparatus of claim 1, wherein:
a mandrel mounting hole in which a first end of the mandrel is mounted is formed at one end of the upper mold; and
an assembly block mounted in the mandrel mounting hole is fastened to a second end of the mandrel.

4. The pultrusion molding apparatus of claim 3, wherein:
a front surface of the assembly block is inclined downward; and
an upper fiber inlet through which the fiber is provided into between the upper mold and the mandrel is formed on a surface of the upper mold facing the front surface of the assembly block.

5. The pultrusion molding apparatus of claim 4, wherein:
the front surface of the assembly block and the upper fiber inlet of the upper mold are parallel to each other; and
a first gap is formed between the front surface of the assembly block and the upper fiber inlet.

6. The pultrusion molding apparatus of claim 3, wherein:
a lower fiber inlet is formed at one end of the lower mold; the lower fiber inlet is parallel to a bottom surface of the assembly block;
a second gap is formed between the lower fiber inlet and the bottom surface of the assembly block; and
the fiber is provided into between the lower mold and the mandrel through the second gap.

7. The pultrusion molding apparatus of claim 3, wherein:
an upper resin inlet through which the resin is injected into an interior of the upper mold is configured to pass through the upper mold at a predetermined distance from the assembly block; and
a lower resin inlet through which the resin is injected into an interior of the lower mold is configured to pass through the lower mold below the upper resin inlet.

8. The pultrusion molding apparatus of claim 7, wherein:
a cross-sectional area of a portion where the upper resin inlet and the lower resin inlet intersect in the mandrel is smaller than cross-sectional areas of other portions of the mandrel; and
the upper mold and the lower mold are each formed to have a thin thickness.

9. The pultrusion molding apparatus of claim 7, wherein the fiber provided into the upper mold and the lower mold includes:
a reinforced fiber disposed inside the vehicle member; and
a non-woven fabric which is disposed on a surface of the vehicle member and configured to prevent the reinforced fiber from being separated.

10. The pultrusion molding apparatus of claim 9, wherein:
an upper reinforced fiber molded into an upper portion of the vehicle member, and an outer upper non-woven fabric and an inner upper non-woven fabric surrounding upper and lower portions of the upper reinforced fiber are provided into between the upper mold and the mandrel; and
a lower reinforced fiber molded into a lower portion of the vehicle member and the at least one rib of the vehicle member, a lower side non-woven fabric surrounding both side surfaces of the lower reinforced fiber, an inner lower non-woven fabric surrounding an interior of the lower reinforced fiber, and an outer lower non-woven fabric surrounding a lower portion of the lower reinforced fiber are provided into between the lower mold and the mandrel.

11. The pultrusion molding apparatus of claim 9, wherein:
an upper reinforced fiber molded into an upper portion of the vehicle member, and an outer upper non-woven fabric and an inner upper non-woven fabric surrounding upper and lower portions of the upper reinforced fiber are provided into between the upper mold and the mandrel; and
a lower reinforced fiber molded into a lower portion of the vehicle member and the at least one rib of the vehicle member, an inner lower non-woven fabric surrounding both side surfaces and an interior of the lower reinforced fiber, and an outer lower non-woven fabric surrounding a lower portion of the lower reinforced fiber are provided into between the lower mold and the mandrel.

12. The pultrusion molding apparatus of claim 1, further comprising:
a plurality of pullers configured to convey the vehicle member discharged from the molding unit in a longitudinal direction of the vehicle member.

13. The pultrusion molding apparatus of claim 12, wherein each of the plurality of pullers includes:
a housing; and
a roller rotatably installed inside the housing and configured to convey the vehicle member by coming into contact with upper and lower surfaces of the vehicle member passing through an interior of the housing.

14. The pultrusion molding apparatus of claim 13, wherein each puller further includes a conveying plate configured to support the upper and lower surfaces of the vehicle member inside the housing.

15. The pultrusion molding apparatus of claim 12, wherein the plurality of pullers is disposed at intervals in a direction in which the vehicle member is discharged.

16. The pultrusion molding apparatus of claim 1, wherein one end of the molding unit is connected to a fixing unit configured to guide and fix a position of the fiber to be provided into the upper mold and the lower mold.

17. A pultrusion molding apparatus for manufacturing a vehicle member, the pultrusion molding apparatus comprising:
a molding unit configured to mold a vehicle member having at least one rib by applying a reinforced fiber and a non-woven fabric while impregnating the reinforced fiber passing therein with a resin,
a plurality of pullers configured to convey the vehicle member discharged from the molding unit in a longitudinal direction of the vehicle member,
a guide unit configured to guide the reinforced fiber and the non-woven fabric to be supplied to the molding unit, and
a fixing unit configured to fix the guide unit against the molding unit.

18. The pultrusion molding apparatus of claim 17, wherein the guide unit includes a plurality of guide plates disposed at intervals in the longitudinal direction of the vehicle member, and through-holes through which the reinforced fiber and the non-woven fabric pass.

19. The pultrusion molding apparatus of claim 18, wherein the molding unit includes:
an upper mold in which a first space is formed;
a lower mold disposed below the upper mold and having a second space corresponding to the first space of the upper mold; and
a mandrel inserted into the first and second spaces between the upper mold and the lower mold and having one end fastened to the upper mold.

20. The pultrusion molding apparatus of claim 19, wherein the molding unit further includes:
a mandrel mounting hole in which a first end of the mandrel is mounted is formed at one end of the upper mold; and
an assembly block mounted in the mandrel mounting hole is fastened to a second end of the mandrel.
